(19) United States
(12) Patent Application Publication
(10) Pub. No.: US 2022/0402112 A1
(43) Pub. Date: Dec. 22, 2022

(54) Handle of Hand Tool

(71) Applicant: KABO Tool Company, Taichung City (TW)

(72) Inventor: Chih-Ching Hsieh, Taichung City (TW)

(21) Appl. No.: 17/807,035

(22) Filed: Jun. 15, 2022

(30) Foreign Application Priority Data
Jun. 18, 2021 (TW) 110122449

(51) Int. Cl. B25G 1/10

(52) U.S. Cl. CPC B25G 1/102

(57) ABSTRACT

A handle of a hand tool includes a main body with a front annular portion, a gripping portion, and a tail portion. The gripping portion has a first expanded section and a reduced section. The outer diameter of the first expanded section, whose front end is connected to the front annular portion, is increased rearward. The outer diameter of the reduced section, which is connected to the rear end of the first expanded section, is reduced rearward. The tail portion has a second expanded section and a closure section. The outer diameter of the second expanded section, whose front end is connected to the rear end of the reduced section, is increased rearward. The outer diameter of the closure section, whose front end is connected to the second expanded section, is reduced rearward. The junction between the reduced section and the second expanded section forms an annular recess.

### BACKGROUND OF THE INVENTION

### 1. Technical Field

The present invention relates to a handle and more particularly to a handle of a hand tool.

### 2. Description of Related Art

Hand tools are designed to be operated manually and are therefore always provided with a handle to be gripped by an operator's hand. FIG. 1 shows a conventional hand tool 10 with a handle 12. The outer diameter of the handle 12 is reduced from the front end of the handle 12 toward the rear end.

The outer diameter of the handle 12 is gradually reduced rearward to facilitate gripping, but the simple curved contour of the handle 12 does not provide a reliably firm grip and hence leaves room for improvement.

### BRIEF SUMMARY OF THE INVENTION

The present invention aims to solve the aforesaid drawback of the prior art, the primary objective being to provide a handle of a hand tool, wherein the handle can be gripped more firmly by a user than its prior art counterparts.

To achieve the foregoing objective, the present invention provides a handle of a hand tool, wherein the handle includes a main body with a front annular portion, a gripping portion, and a tail portion.

The main body has a circular cross section. The main body has a front end and a rear end. The main body is sequentially formed with the front annular portion, the gripping portion, and the tail portion along a longitudinal direction, or more particularly from its front end toward its rear end.

The front annular portion is provided at the front end of the main body and has a front edge whose outer diameter is gradually increased rearward, a middle area having the greatest outer diameter of the front annular portion, and a rear edge whose outer diameter is gradually reduced rearward.

The gripping portion has a first expanded section and a reduced section. The outer diameter of the first expanded section is increased rearward, and the front end of the first expanded section is connected to the rear edge of the front annular portion. The front end of the reduced section is connected to the rear end of the first expanded section, and the outer diameter of the reduced section is reduced rearward. The junction between the first expanded section and the reduced section has the greatest outer diameter of the gripping portion.

The tail portion has a second expanded section and a closure section. The front end of the second expanded section is connected to the rear end of the reduced section of the gripping portion, and the outer diameter of the second expanded section is increased rearward. The front end of the closure section is connected to the rear end of the second expanded section, and the outer diameter of the closure section is reduced rearward. The junction between the reduced section of the gripping portion and the second expanded section of the tail portion forms an annular recess. The junction between the second expanded section and the closure section has the greatest outer diameter of the tail portion.

The undulating contour design of the handle is ergonomic and allows the handle to be firmly gripped.

In one embodiment of the present invention, the front end of the first expanded section of the gripping portion includes a joining section. The outer diameter of the joining section is slightly reduced rearward, so the outer diameter of the first expanded section is gradually increased only rearward of the joining section. The front end of the joining section of the first expanded section is connected to the rear edge of the front annular portion.

In one embodiment of the present invention, the joining section has an outer periphery defined by a concavely curved line segment having a relatively large curvature.

In one embodiment of the present invention, the closure section of the tail portion has an outer periphery defined by a convexly curved line segment.

In one embodiment of the present invention, the length of the gripping portion is 0.63 to 0.72 times the length of the handle.

In one embodiment of the present invention, the length of the first expanded section is 0.85 to 0.94 times the length of the gripping portion.

In one embodiment of the present invention, the length of the tail portion is 0.19 to 0.25 times the length of the handle.

In one embodiment of the present invention, the outer diameter of the first expanded section and the outer diameter of the second expanded section are increased rearward in such a way that the outer periphery of the first expanded section has a smaller rearward slope than the outer periphery of the second expanded section.

In one embodiment of the present invention, the greatest outer diameter of the gripping portion and the greatest outer diameter of the tail portion have a percent difference smaller than or equal to 8%.

In one embodiment of the present invention, the handle further includes at least one annular groove, at least one color band, or at least one annular area with a rugged pattern, provided in the annular recess or in/on the tail portion to enhance the identifiability and/or friction of the handle.

### BRIEF DESCRIPTION OF THE SEVERAL VIEWS OF THE DRAWINGS

The foregoing and other objectives, as well as the features and intended effects, of the present invention can be better understood by referring to the following detailed description of some preferred embodiments in conjunction with the accompanying drawings, in which:

FIG. 1 shows a conventional hand tool;

FIG. 2 is a rear perspective view of the handle according to the first preferred embodiment of the invention, showing the handle mounted on a hand tool;

FIG. 3 is a side view of the handle in FIG. 2;

FIG. 4 shows the handle of the invention being gripped by a user;

FIG. 5 is a rear perspective view of the handle according to the second preferred embodiment of the invention;

FIG. 6 is a side view of the handle in FIG. 5;

FIG. 7 is a side view of the handle according to the third preferred embodiment of the invention; and

FIG. 8 is a side view of the handle according to the fourth preferred embodiment of the invention.

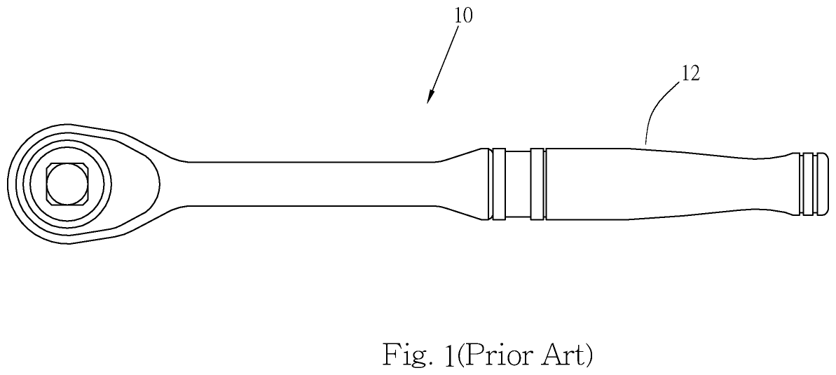

### DETAILED DESCRIPTION OF THE INVENTION

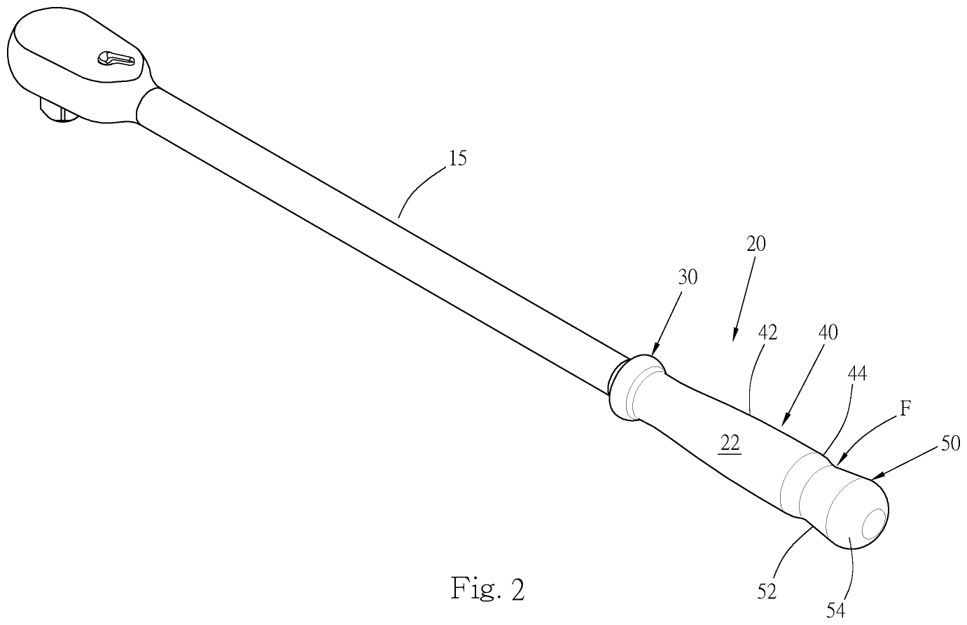

The present invention provides a handle of a hand tool. Referring to FIG. 2, the handle 20 of the invention is mounted at a terminal end of a hand tool 15. The hand tool 15 in FIG. 2 is a wrench by way of example only. The handle 20 of the invention may alternatively be mounted on a screwdriver, a hammer, a knife, a hoe, a rake, a saw, or other types of hand tools.

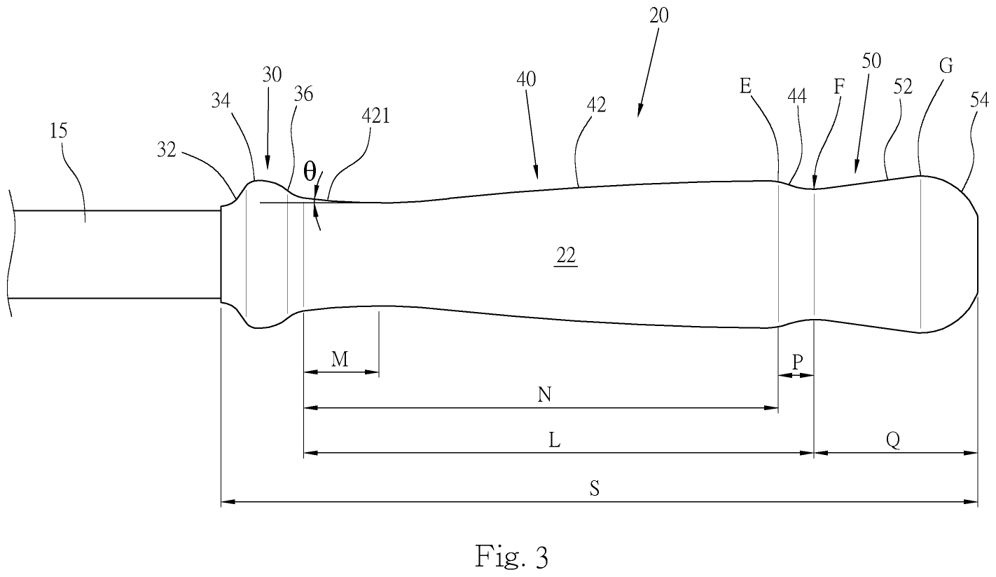

Referring to FIG. 3, the handle 20 has a generally barrel-shaped main body 22, which has a circular cross section throughout. A hole (not shown) is provided at, and extends into, the front end of the main body 22, and the corresponding terminal end of the shaft of the hand tool 15 is fitted in the hole. The main body 22 as well as the handle 20 has a longitudinal direction extending through the front and rear ends of the main body 22. Moreover, the handle 20 includes a front annular portion 30, a gripping portion 40, and a tail portion 50, the three of which are sequentially formed on the main body 22 along the longitudinal direction of the handle 20, or more particularly from the front end of the main body 22 toward the rear end. Both the gripping portion 40 and the tail portion 50 are so designed that their outer diameters are gradually increased rearward for the most part. The configurations of the gripping portion 40 and of the tail portion 50 render the handle 20 of the present invention into a calabash-shaped structure. The length of the gripping portion 40 is greater than that of the tail portion 50.

The front annular portion 30 is provided at the front end of the main body 22 and has a front edge 32 whose outer diameter is gradually increased rearward, a middle area 34 having the greatest outer diameter of the front annular portion 30, and a rear edge 36 whose outer diameter is gradually reduced rearward. The front edge 32, the middle area 34, and the rear edge 36 are sequentially connected.

The gripping portion 40 is a portion whose outer diameter is gradually increased rearward for the most part, and the length of the gripping portion 40 makes up most of the length of the handle 20. Preferably, the length L of the gripping portion 40 is about two thirds of the length S of the handle 20 and ranges from 0.63 to 0.72 times the length S of the handle 20. More specifically, the gripping portion 40 has a first expanded section 42 (hereinafter referred to as the expanded section 42 for short) whose outer diameter is increased rearward and a reduced section 44 connected to the rear end of the expanded section 42 and having an outer diameter that is reduced rearward. The front end of the expanded section 42 is connected to the rear edge 36 of the front annular portion 30. To enable a smooth connection between the front end of the gripping portion 40 and the front annular portion 30, the expanded section 42 includes a joining section 421 located at the front end of the expanded section 42. The outer diameter of the joining section 421 is slightly reduced rearward such that the outer periphery of the joining section 421 forms a small angle θ with the longitudinal direction, wherein the angle θ preferably ranges from 5 to 10 degrees, more preferably from 6 to 8 degrees. The length M of the joining section 421 is about 0.15 times the length L of the gripping portion 40 and is approximately 0.3 to 0.5 times the length N of the expanded section 42. In a side view as shown in FIG. 3, the outer periphery of the joining section 421 is defined by a concavely curved line segment having a relatively large curvature. The joining section 421 terminates where the outer diameter of the gripping portion 40 stops decreasing rearward and begins to increase rearward.

The front end of the reduced section 44 is connected to the rear end of the expanded section 42, and the outer diameter of the reduced section 44 is gradually reduced rearward. The greatest outer diameter of the gripping portion 40 occurs at the junction E between the expanded section 42 and the reduced section 44. The length N of the first expanded section 42 is about 0.85 to 0.94 times, preferably 0.9 times, the length L of the gripping portion 40. The length P of the reduced section 44 is about 0.06 to 0.15 times, preferably 0.1 times, the length L of the gripping portion 40.

The outer diameter of the tail portion 50 is also gradually increased rearward for the most part and has a second expanded section 52 (hereinafter referred to as the expanded section 52 for short) and a closure section 54. The outer diameter of the expanded section 52 is increased rearward. The front end of the closure section 54 is connected to the rear end of the expanded section 52, and the outer diameter of the closure section 54 is reduced rearward. In a side view as shown in FIG. 3, the outer periphery of the closure section 54 is defined by a convexly curved line segment.

The junction between the reduced section 44 of the gripping portion 40 and the expanded section 52 of the tail portion 50 forms an annular recess F. The greatest outer diameter of the tail portion 50 occurs at the junction G between the expanded section 52 and the closure section 54. The length Q of the tail portion 50 is about 0.19 to 0.25 times the length S of the handle 20.

Each portion of the handle 20 of the present invention is generally in the shape of a truncated cone. The length L of the gripping portion 40 is greater than the length Q of the tail portion 50. The greatest outer diameter of the gripping portion 40 (i.e., the outer diameter at the junction E) is the same or approximately the same as the greatest outer diameter of the tail portion 50 (i.e., the outer diameter at the junction G). The greatest outer diameter of the gripping portion 40 and the greatest outer diameter of the tail portion 50 have a percent difference not greater than ±8%. For example, both portions 40 and 50 have the same greatest outer diameter of 50 mm, or the greatest outer diameter of the gripping portion 40 is 48 mm while the greatest outer diameter of the tail portion 50 is 50 mm, with the percent difference being 4%. Furthermore, the outer diameter of the first expanded section 42 and the outer diameter of the second expanded section 52 are increased rearward in such a way that the outer periphery of the first expanded section 42 has a smaller rearward slope than the outer periphery of the second expanded section 52.

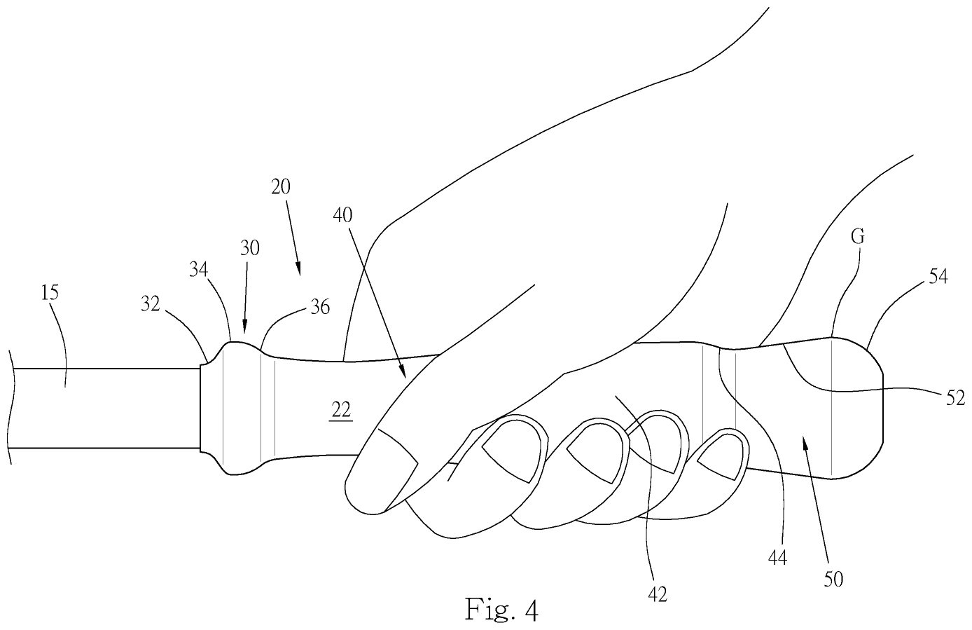

To use the hand tool 15, the user holds the handle 20 of the hand tool 15 in one hand. As shown in FIG. 4, the gripping portion 40 of the handle 20 is gripped in the user's palm, with the reduced section 44 of the gripping portion 40 gripped by the ulnar edge of the palm and the little finger, both positioned in the annular recess F. It is the expanded section 42 of the gripping portion 40 that the user's palm mainly grips. The rearwardly increased outer diameter of the expanded section 42 not only allows the user's palm to take a firm grip on the handle 20, but also prevents the handle 20 and the hand tool 15 from sliding forward. The handle 20 is also kept from sliding off the palm by the ulnar edge of the palm gripping the portion corresponding to the annular recess F. The expanded section 42 and the annular recess F of the handle 20 form an undulating configuration that provides an ergonomic design and enables a firm grip by allowing the user's palm to lie compliantly on the handle 20. The rearwardly increased outer diameter of the tail portion 50 prevents the handle 20 from sliding off, too.

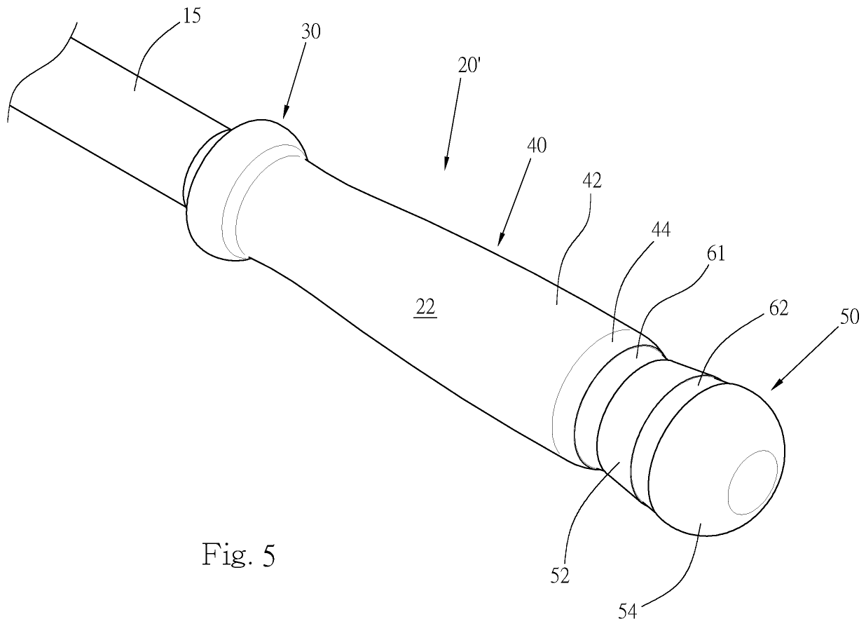

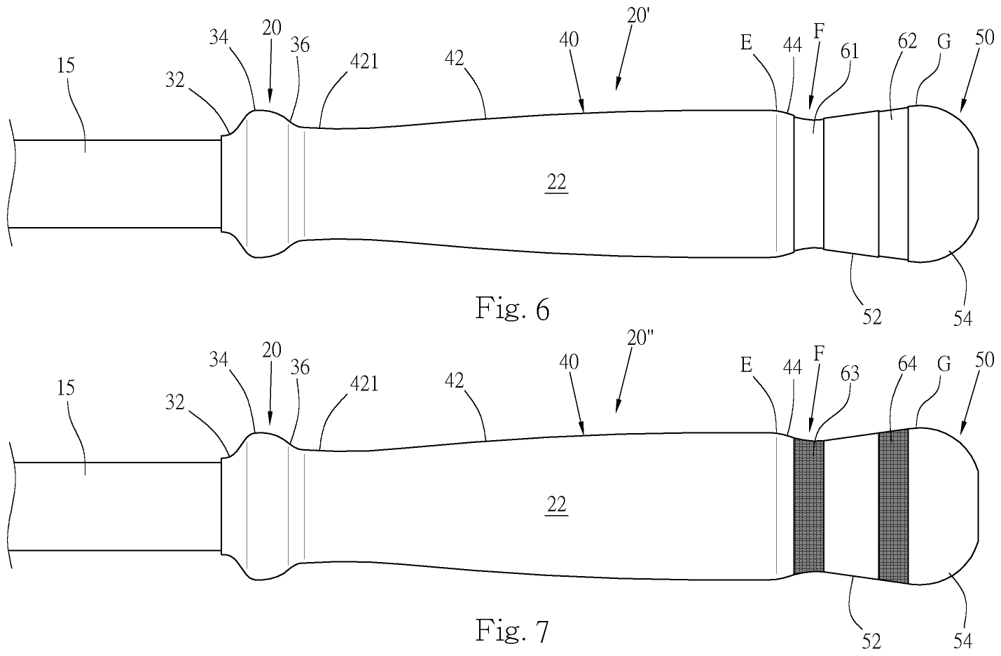

FIG. 5 and FIG. 6 show the handle 20′ according to the second preferred embodiment of the present invention. The same components in the first and the second preferred embodiments use the same reference numeral, and the structural features of such components can be understood from the first preferred embodiment and therefore will not be described repeatedly.

The main body 22 of the handle 20′ is also formed with a front annular portion 30, a gripping portion 40, and a tail portion 50. The gripping portion 40 and the tail portion 50 are so designed that their outer diameters are gradually increased rearward for the most part. The handle 20′ further includes a first annular groove 61 and a second annular groove 62, which are provided in the annular recess F and in the peripheral surface of the expanded section 52 of the tail portion 50 respectively. The two annular grooves 61 and 62 serve handle identification purposes. The first annular groove 61 also helps increase the contact between the handle 20′ and a user's palm.

FIG. 7 shows the handle 20″ according to the third preferred embodiment of the present invention. The same components in the first and the third preferred embodiments use the same reference numeral, and the structural features of such components can be understood from the first preferred embodiment and therefore will not be described repeatedly.

The handle 20″ also has a front annular portion 30, a gripping portion 40, and a tail portion 50, the three of which are sequentially formed on the main body 22 of the handle 20″ from the front end of the main body 22 toward the rear end. Both the gripping portion 40 and the tail portion 50 are so designed that their outer diameters are gradually increased rearward for the most part.

A first color band 63 made of a polymer material, a metal, or the like is provided in, and along the circumference of, the annular recess F. A second color band 64 made of a polymer material, a metal, or the like is provided on, and along the circumference of, the peripheral surface of the expanded section 52 of the tail portion 50. The two color bands 63 and 64 may differ in color from the main body 22 and from each other to enhance the identifiability of the handle 20″. In addition, the two color bands 63 and 64 may provide a different frictional force from that by the main body 22 so as to increase the contact friction between a user's palm and the handle 20″.

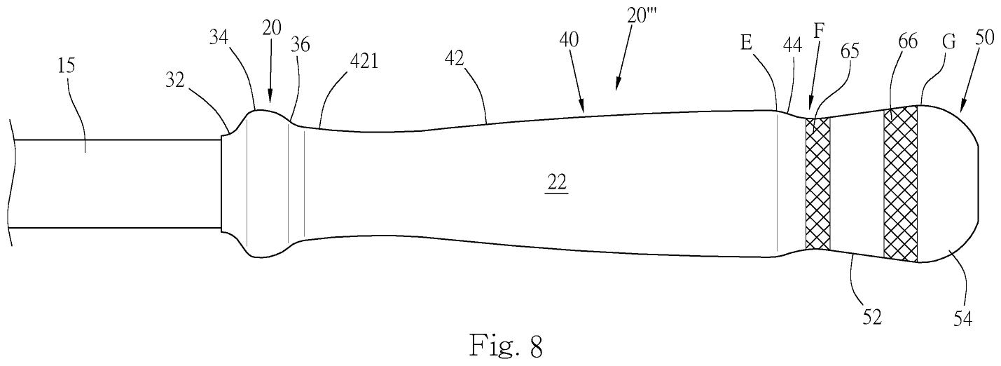

FIG. 8 shows the handle 20′″ according to the fourth preferred embodiment of the present invention. The same components in this and the first preferred embodiments use the same reference numeral, and the structural features of such components can be understood from the first preferred embodiment and therefore will not be described repeatedly.

The handle 20′″ also has a front annular portion 30, a gripping portion 40, and a tail portion 50, the three of which are sequentially formed on the main body 22 of the handle 20′″ from the front end of the main body 22 toward the rear end. Both the gripping portion 40 and the tail portion 50 are so designed that their outer diameters are gradually increased rearward for the most part.

A first annular area 65 with a rugged pattern is provided in the annular recess F, and a second annular area 66 with a rugged pattern is provided on the peripheral surface of the expanded section 52 of the tail portion 50. The two annular patterned areas 65 and 66 help increase the contact friction between a user's palm and the handle 20″.

In practice, at least one annular groove, at least one color band, or at least one annular area with a rugged pattern may be provided in/on at least one of the annular recess and the tail portion.

The handle 20 (20′, 20″, 20′″) of the present invention has two portions (i.e., the gripping portion 40 and the tail portion 50) that are similar in configuration, have rearwardly increased outer diameters, and form the annular recess F at the junction between the two portions 40 and 50. According to the tests conducted by the applicant, this undulating structural configuration is ergonomic and allows the handle to be firmly gripped.

The embodiments disclosed above serve only to expound, but not to limit, the technical features of the present invention. Any equivalent modification based on the contents disclosed herein shall fall within the scope of the patent protection sought by the applicant for the invention.

What is claimed is:

1. A handle of a hand tool, comprising:
a main body having a circular cross section throughout, wherein the main body has a front end and a rear end, and the main body is formed with:
a front annular portion provided at the front end of the main body and having a front edge, a middle area, and a rear edge, wherein an outer diameter of the front edge is gradually increased rearward, the middle area has a greatest outer diameter of the front annular portion, and an outer diameter of the rear edge is gradually reduced rearward;
a gripping portion, wherein an outer diameter of the gripping portion is generally increased rearward, the gripping portion has a first expanded section and a reduced section, an outer diameter of the first expanded section is increased rearward, the first expanded section has a front end connected to the rear edge of the front annular portion, the reduced section has a front end connected to a rear end of the first expanded section, an outer diameter of the reduced section is reduced rearward, and a junction between the first expanded section and the reduced section has the greatest outer diameter of the gripping portion; and
a tail portion, wherein an outer diameter of the tail portion is generally increased rearward, the tail portion has a second expanded section and a closure section, the second expanded section has a front end connected to a rear end of the reduced section of the gripping portion, an outer diameter of the second expanded section is increased rearward, the closure section has a front end connected to a rear end of the second expanded section, an outer diameter of the closure section is reduced rearward, a junction between the reduced section of the gripping portion and the second expanded section of the tail portion forms an annular recess, and a junction between the second expanded section and the closure section has the greatest outer diameter of the tail portion.

2. The handle of claim 1, wherein the first expanded section of the gripping portion includes a joining section provided at the front end of the first expanded section, an outer diameter of the joining section is slightly reduced rearward, the outer diameter of the first expanded section is gradually increased rearward of the joining section, and the joining section of the first expanded section has a front end connected to the rear edge of the front annular portion.

3. The handle of claim 2, wherein the joining section has an outer periphery defined by a concavely curved line segment having a relatively large curvature.

4. The handle of claim 1, wherein the closure section of the tail portion has an outer periphery defined by a convexly curved line segment.

5. The handle of claim 1, wherein the gripping portion is 0.63 to 0.72 times as long as the handle.

6. The handle of claim 1, wherein the first expanded section is 0.85 to 0.94 times as long as the gripping portion.

7. The handle of claim 1, wherein the tail portion is 0.19 to 0.25 times as long as the handle.

8. The handle of claim 1, wherein the outer diameter of the first expanded section and the outer diameter of the second expanded section are increased rearward in such a way that an outer periphery of the first expanded section has a smaller rearward slope than an outer periphery of the second expanded section.

9. The handle of claim 1, wherein the greatest outer diameter of the gripping portion and the greatest outer diameter of the tail portion have a percent difference not greater than 8%.

10. The handle of claim 1, further comprising at least one annular groove provided in at least one of the annular recess and the tail portion.

11. The handle of claim 1, further comprising at least one color band provided in/on at least one of the annular recess and the tail portion.

12. The handle of claim 1, further comprising at least one annular area with a rugged pattern, provided in/on at least one of the annular recess and the tail portion.
